(19) United States
(12) Patent Application Publication
(10) Pub. No.: US 2009/0103403 A1
(43) Pub. Date: Apr. 23, 2009

(54) OPTICAL DISC APPARATUS AND LENS SHIFT CORRECTION METHOD

(76) Inventor: Hideo KUROSAWA, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/039,194

(22) Filed: Feb. 28, 2008

(30) Foreign Application Priority Data
Oct. 19, 2007 (JP) 2007-272870

(51) Int. Cl. G11B 7/095; G11B 7/09

(52) U.S. Cl. 369/44.29

(57) ABSTRACT

An optical disc apparatus, which executes tracking control for an objective lens by generating a push-pull signal, includes a determination unit which detects symmetry of the push-pull signal and determines whether balance of signal characteristics of the push-pull signal is good, a lens shift amount detection unit which detects, in a case where the determination unit determines that the balance of the signal characteristics of the push-pull signal is not good, a lens shift amount of the objective lens in such a manner as to improve the balance of the signal characteristics, a memory unit which stores the lens shift amount that is detected by the lens shift amount detection unit, and an addition unit which constantly applies the lens shift amount, which is stored in the memory unit, to a tracking actuator which shifts the objective lens.

### CROSS-REFERENCE TO RELATED APPLICATIONS

This application is based upon and claims the benefit of priority from prior Japanese Patent Application No. 2007-272870, filed Oct. 19, 2007, the entire contents of which are incorporated herein by reference.

### BACKGROUND OF THE INVENTION

1. Field of the Invention

The present invention relates to an optical disc apparatus which executes position correction of an objective lens, and a lens shift correction method.

2. Description of the Related Art

With development of optical disc apparatuses, models of apparatuses have been changing from a thick type (Half Height (H/H)) to a thin type (slim) to an ultra-slim type. The optical disc apparatus of the thick type (H/H) model has a thickness of, e.g. 41.5 mm. The optical disc apparatus of the thin type model has a thickness of 12.7 mm, and the optical disc apparatus of the ultra-thin type has a thickness of 9.5 mm.

In general, in the optical disc apparatus, the position correction of the objective lens of the optical pickup head is executed (for example, Jpn. Pat. Appln. KOKAI Publication No. 2002-304752).

In an optical disc apparatus disclosed in Jpn. Pat. Appln. KOKAI Publication No. 2002-304752, an objective lens of the optical pickup is shifted from the optical axial center, and the objective lens position is optimized so as not to adversely affect the quality of reproduction/recording. The optical disc apparatus disclosed in Japanese KOKAI No. 2002-304752 is configured such that the position of the objective lens is arbitrarily movable relative to output light of a light source. Using a trial write area of a recording type optical disc, the position of the objective lens, while being moved, is recorded. An optimal objective lens position is detected from a parameter which is obtained by reproducing the recorded area or from a parameter which is obtained from reflective light during the recording. Thus, the objective lens position is corrected, and the objective lens is positioned at the optimal objective lens position.

As described above, in the conventional optical disc apparatus, the position of the objective lens is corrected. There is a characteristic that a signal variation corresponding to a shift of the objective lens is greater as the thickness of the apparatus becomes smaller, as in the case of the ultra-slim model.

In the ultra-slim optical disc apparatus, it is necessary to reduce the size of the optical pickup head itself, and a light beam in the optical pickup head is thin. In this case, in accordance with a shift of the objective lens, the beam spot that is projected on the photodiode of the optical pickup head greatly moves, compared to the thick-type model. In other words, in the optical disc apparatus of the ultra-slim model, the variation of the signal output from the photodiode, relative to the shift of the objective lens, is greater than in the case of the thick-type model.

In general, in the optical disc apparatus, a lens shift occurs due to the influence of warpage of the optical disc or eccentricity of the spindle motor. The signal variation due to such a lens shift also becomes greater in the ultra-slim optical disc apparatus.

Thus, the following measures have to be taken. For example, saturation is prevented from occurring in a rear-stage circuit which processes a signal from the optical pickup head, for instance, an RF amplifier, by increasing the dynamic range in accordance with a greatly varying output signal. In another case, the output signal from the optical pickup head has to be attenuated in accordance with the dynamic range of the RF amplifier.

In this case, the dynamic range of the RF amplifier cannot effectively be utilized for the signal that is output from the optical pickup head, and the S/N decreases, leading to degradation in signal quality.

### BRIEF SUMMARY OF THE INVENTION

According to an aspect of the present invention, there is provided an optical disc apparatus which executes tracking control for an objective lens by generating a push-pull signal, comprising: a determination unit which detects symmetry of the push-pull signal and determines whether balance of signal characteristics of the push-pull signal is good; a lens shift amount detection unit which detects, in a case where the determination unit determines that the balance of the signal characteristics of the push-pull signal is not good, a lens shift amount of the objective lens in such a manner as to improve the balance of the signal characteristics; a memory unit which stores the lens shift amount that is detected by the lens shift amount detection unit; and an addition unit which constantly applies the lens shift amount, which is stored in the memory unit, to a tracking actuator which shifts the objective lens.

According to the present invention, when the balance of signal characteristics of the push-pull signal is not good (unbalanced), the objective lens is forcibly shifted so as to attain good balance. Since there is no need to increase the dynamic range of the RF amplifier, which is needed for the push-pull signal, the dynamic range of the RF amplifier can effectively be utilized, and degradation in signal quality can be prevented.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the structure of an optical disc apparatus according to an embodiment of the present invention;

FIG. 2 is a block diagram showing a detailed structure relating to tracking control in the present embodiment;

FIG. 3 is a view for explaining application of a bias voltage to a control signal for controlling tracking in the embodiment;

FIG. 4 is a block diagram for explaining generation of a main push-pull signal;

FIG. 5 is a view for explaining the symmetry of the main push-pull signal;

FIG. 6A, FIG. 6B and FIG. 6C show examples of signal characteristics of the main push-pull signal;

FIG. 7 shows an example of symmetry that is generated on the basis of the main push-pull signal;

FIG. 8A and FIG. 8B show the signal characteristics of the main push-pull signal and the symmetry of the main push-pull signal;

FIG. 9A and FIG. 9B show the signal characteristics of the main push-pull signal and the symmetry of the main push-pull signal after the lens position is corrected;

FIG. 10 is a block diagram for explaining measurement of jitter on the basis of the main push-pull signal; and

FIG. 11 is a view for explaining detection of a lens shift amount on the basis of jitter.

### DETAILED DESCRIPTION OF THE INVENTION

An embodiment of the present invention will now be described with reference to the accompanying drawings.

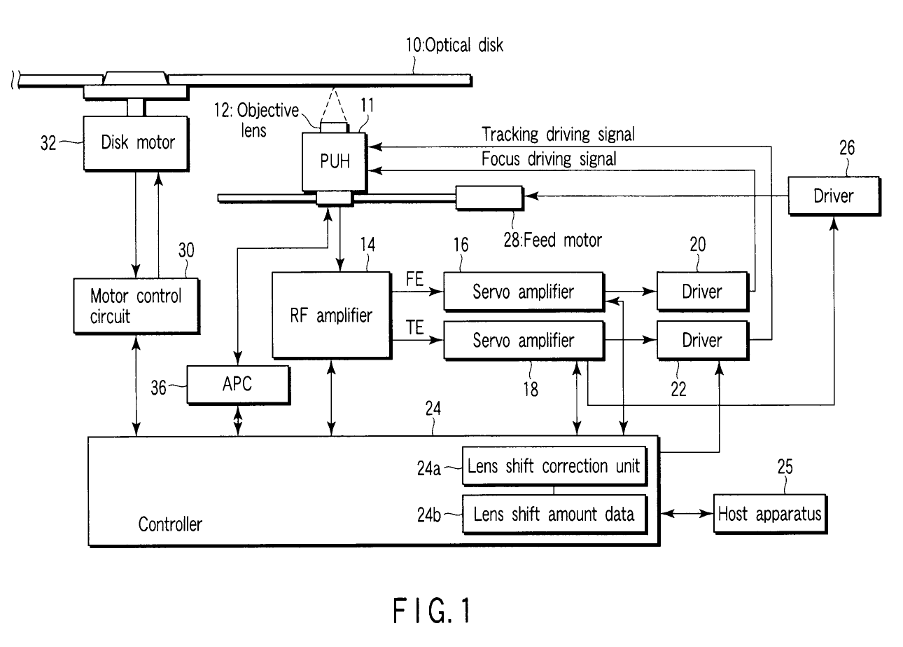

FIG. 1 is a block diagram showing the structure of an optical disc apparatus according to the embodiment.

A spiral track is formed on an optical disc 10 which serves as a recording medium. The optical disc 10 is rotated by a disc motor 32 (e.g. spindle motor) which is driven by a motor control circuit 30.

Recording/reproduction of data on/from the optical disc 10 is effected by a laser beam which is emitted from an optical pickup head (PUH) 11. The optical pickup head 11 is supported at a position facing a data read surface of the optical disc 10 in such a manner that the optical pickup head 11 is movable in a radial direction of the optical disc 10 by a feed motor 28 which is driven by a driver 26. The driver 26 is driven in accordance with a control signal which is generated by a servo amplifier 18.

The optical pickup head 11 includes a laser diode, a collimator lens, a beam splitter, an objective lens 12, a cylindrical lens, a photodetector, a lens position sensor and a monitor diode.

In addition, the optical pickup head 11 is provided with a biaxial actuator which moves the objective lens 12 in two mutually perpendicular directions. Specifically, the optical pickup head 11 is provided with a focusing actuator which adjusts focusing by moving the objective lens 12 in a focusing direction (i.e. an optical axis direction of the optical lens 12), and a tracking actuator which adjusts tracking by moving the objective lens 12 in a tracking direction (i.e. radial direction of the optical disc 10). The focusing actuator is controlled by a focus driving signal which is output from a driver 20. The tracking actuator is controlled by a tracking driving signal from a driver 22.

The laser diode of the optical pickup head 11 is driven by an Auto Power Control (APC) 36 under the control of a controller 24, and outputs a laser beam. The APC 36 controls the ON/OFF of a laser output from the laser diode and the intensity of the laser beam at a time of reproduction or at a time of recording, on the basis of the control of the controller 24. The laser beam that is output from the laser diode is radiated on the optical disc 10 via the collimator lens, beam splitter and objective lens 12.

Reflective light from the optical disc 10 is guided to the photodetector via the objective lens 12, beam splitter and cylindrical lens. The single photodetector comprises, e.g. four divided photodetectors. Signals that are detected by the four photodetectors are amplified to predetermined voltage values and are output to an RF amplifier 14.

The RF amplifier 14 processes a signal from the photodetector of the optical pickup head 11 and outputs the processed signal. For example, the RF amplifier 14 generates and outputs a tracking error signal TE which indicates an error between a beam spot center of the laser beam and a track center, a focus error signal FE which indicates an error from a just-focus position, and an RF signal or an addition signal, in which the signals from the four divided photodetectors are added.

The focus error signal FE from the RF amplifier 14 is output to a servo amplifier 16. The tracking error signal TE (e.g. Differential Push-Pull (DPP) signal) from the RF amplifier 14 is output to the servo amplifier 18.

The servo amplifier 16 amplifies the focus error signal FE that is output from the RF amplifier 14, and outputs via the driver 20 a focus driving signal to the focusing actuator (not shown) of the optical pickup head 11.

The focusing actuator is driven by the focus driving signal that is output from the driver 20, and executes focus servo so that the laser beam from the optical pickup head 11 is made to be just focused on the recording surface of the optical disc 10.

The servo amplifier 18 amplifies the tracking error signal TE which is output from the RF amplifier 14, and outputs via the driver 22 a tracking driving signal to the tracking actuator (not shown) of the optical pickup head 11.

The tracking actuator is driven by the tracking driving signal that is output from the driver 22, and executes tracking servo so as to make the laser beam emitted from the optical pickup head 11 constantly trace the track that is formed on the optical disc 10. The driver 22 in the present embodiment can output, under the control of the controller 24, a tracking driving signal to which a preset value (lens shift amount data to be described later) is constantly added (a bias voltage corresponding to lens shift amount data is applied). The details will be described later.

The controller 24 is configured to include a processor and memories (RAM, ROM, flash memory). The controller 24 causes the processor to execute various programs stored in the memories, thereby executing an overall control of the apparatus.

The controller 24 in the present embodiment includes a lens shift correction unit 24a. The lens shift correction unit 24a determines whether the balance of signal characteristics of the push-pull signal is good or not (well-balanced or not) on the basis of the symmetry of the push-pull signal. If it is determined that the balance is not good (unbalanced), the lens shift correction unit 24a detects the lens shift amount of the objective lens 12 and stores the detected lens shift amount as lens shift amount data 24b, thereby to improve the balance of signal characteristics (well-balanced). The lens shift correction unit 24a constantly applies the bias voltage corresponding to the lens shift amount data 24b to the driver 22. Accordingly, the driver 22 outputs the tracking driving signal in which the balance of signal characteristics is corrected, and the tracking driving signal is supplied to the tracking actuator of the objective lens 12.

The host apparatus 25 outputs various commands to the optical disc apparatus, and controls the operation of the optical disc apparatus. The host apparatus 25 receives data that is read out from the optical disc 10 by the optical disc apparatus, and outputs data, which is to be recorded on the optical disc 10, to the controller 24.

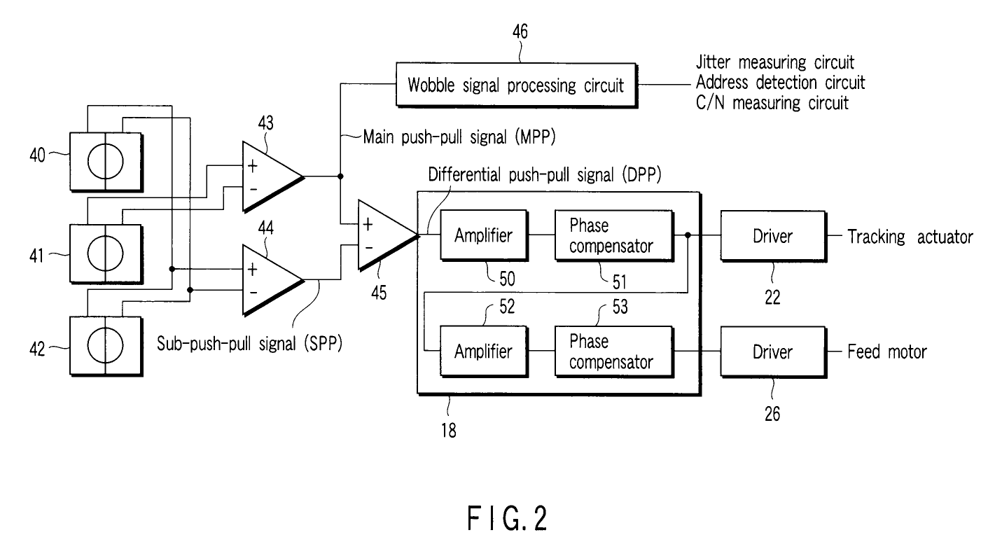

FIG. 2 is a block diagram showing a detailed structure relating to tracking control in the present embodiment.

In the optical disc apparatus according to the present embodiment, it is assumed that a push-pull signal is generated by a 3-beam structure. Specifically, a laser beam, which is output from the photodiode of the optical pickup head 11, is divided to three beams through a diffraction grating which is provided on the optical path, and the three beams are radiated through the objective lens 12 onto the optical disc 10 so as to form three spots. Reflective lights from the optical disc 10 are received by three photodetectors 40, 41 and 42. Each of the photodetectors 40, 41 and 42 shown in FIG. 2 is, for example, a 4-division cell, but is depicted as being a 2-division cell for the purpose of convenience in order to explain the generation of the push-pull signal.

A signal from the photodetector 41 is output as a main push-pull signal (MPP) via a subtracter 43. Signals from the photodetectors 40 and 42 are output via a subtracter 44 as a sub-push-pull (SPP) signal. The main push-pull signal MPP and the sub-push-pull signal SPP are mixed by a subtracter 45 into a differential push-pull (DPP) signal.

The servo amplifier 18 receives the differential push-pull DPP, generates a control signal for controlling tracking by subjecting the differential push-pull DPP to amplification by an amplifier 50 and phase compensation by a phase compensator 51, and outputs the generated control signal to the driver 22. In accordance with the control signal from the servo amplifier 18, the driver 22 outputs a tracking driving signal to the tracking actuator of the objective lens 12.

The control signal, which has been subjected to the phase compensation by the phase compensator 51, is further subjected to amplification by an amplifier 52 and phase compensation by a phase compensator 53, and is output to the driver 26 as a control signal to the feed motor 28.

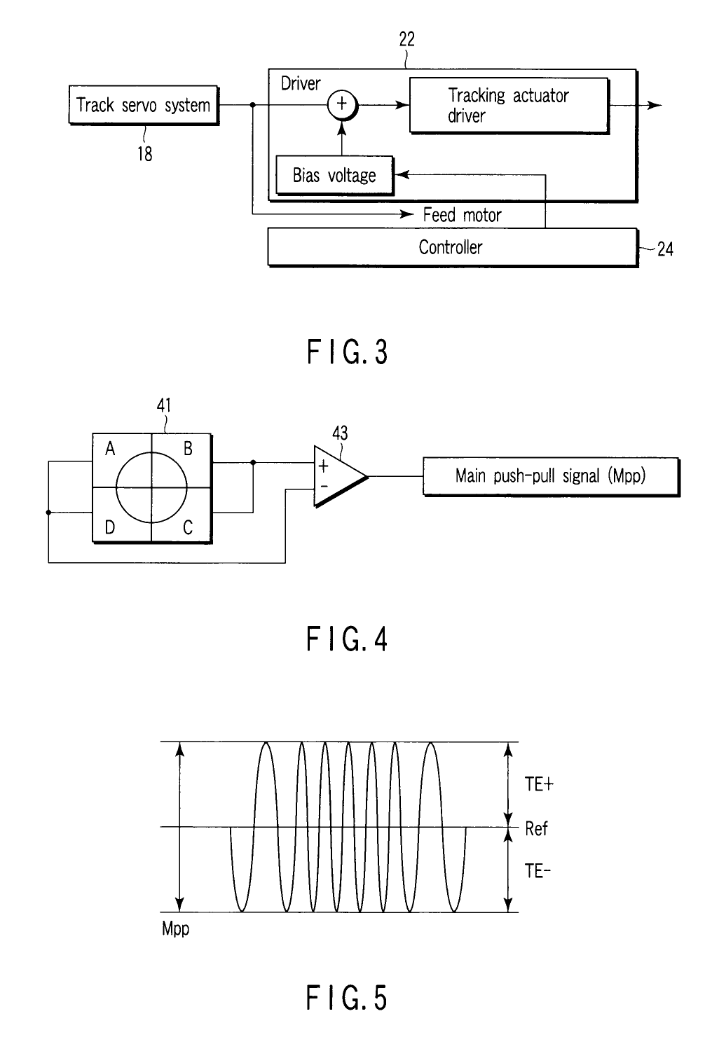

FIG. 3 is a view for explaining application of a bias voltage to a control signal for controlling tracking in the driver 22.

In the driver 22, a bias voltage, which corresponds to the lens shift amount data 24b, is constantly applied to the control signal from the serve amplifier 18 under the control of the lens shift correction unit 24a of the controller 24. Thereby, the driver 22 outputs a tracking driving signal to which a lens shift corresponding to the bias voltage is added (shift correction), and supplies the tracking driving signal to the tracking actuator of the objective lens 12.

FIG. 4 is a block diagram for explaining generation of a main push-pull signal Mpp.

As shown in FIG. 4, the main push-pull signal Mpp is given by the following equation, on the basis of output signals from cells A, B, C and D of the 4-division photodetector 41:

main push-pull signal Mpp=(A+D)−(B+C).

FIG. 5 is a view for explaining the symmetry of the main push-pull signal Mpp.

The symmetry of the main push-pull signal Mpp is calculated by the following equation from the main push-pull signal Mpp:

Mpp symmetry (%)={[(TE+)−(TE−)]/2}/Mpp×100.

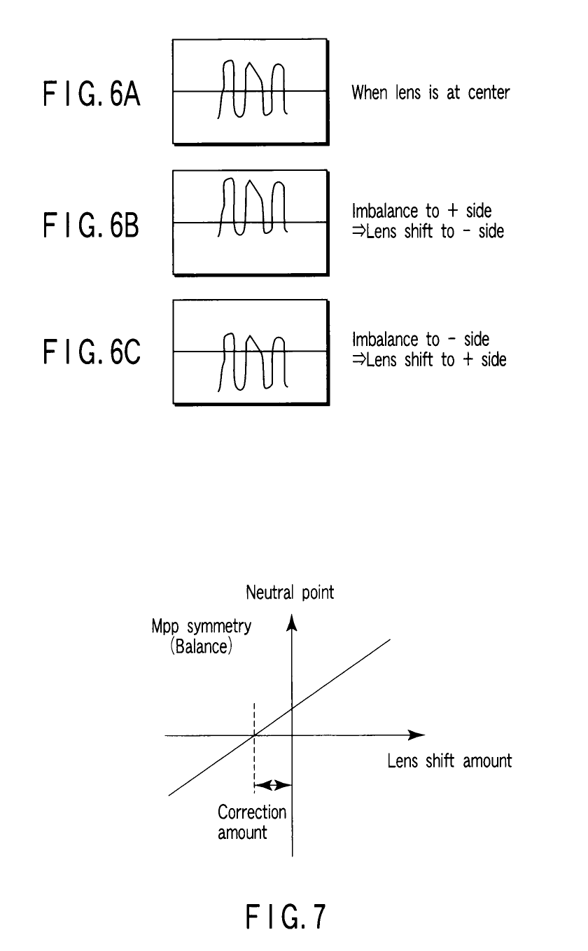

FIG. 6A, FIG. 6B and FIG. 6C show examples of signal characteristics of the main push-pull signal Mpp.

FIG. 6A shows a state in which the balance of the main push-pull signal Mpp is good (i.e. the main push-pull signal is balanced). Specifically, in the main push-pull signal Mpp, an upper-side voltage amplitude value “TE+” relative to a reference voltage (Ref) in FIG. 5 and a lower-side voltage amplitude value “TE−” relative to the reference voltage (Ref) are substantially equal.

FIG. 6B and FIG. 6C show states in which the balance of the main push-pull signal Mpp is not good (i.e. the main push-pull signal is not balanced). In the example of the main push-pull signal Mpp shown in FIG. 6B, there is an imbalance to the upper side (+side). In this case, the well-balance state as shown in FIG. 6A can be obtained by shifting the objective lens 12 so that the main push-pull signal Mpp varies to the lower side (−side).

In the example of the main push-pull signal Mpp shown in FIG. 6C, there is an imbalance to the lower side (−side). FIG. 7 shows symmetry which is generated on the basis of the main push-pull signal Mpp shown in FIG. 6C. In this case, the well-balance state as shown in FIG. 6A can be obtained by shifting the objective lens 12 so that the main push-pull signal Mpp varies to the upper side (+side). In other words, by shifting the objective lens 12 so that the zero-cross point of the symmetry may agree with the neutral point of the objective lens 12, well-balanced signal characteristics of the main push-pull signal Mpp can be obtained.

Next, the lens shift correction method of the optical disc apparatus according to the present embodiment is described.

It is assumed that the optical disc apparatus according to the present embodiment is composed of, for example, a so-called “ultra-slim” thin-type model.

To begin with, the controller 24 of the optical disc apparatus detects that the optical disc 10 is loaded, and then drives the feed motor 28 via the driver 26, thereby moving the optical pickup head 11 to a predetermined position. A laser beam is radiated onto the optical disc 10 from the optical pickup head 11, and the kind of the optical disc 10 is determined from a detection signal which is generated in accordance with reflective light from the optical disc 10.

In accordance with the disc type of the optical disc 10, the controller 24 selects a laser beam which is radiated on the optical disc 10 from the optical pickup head 11 through the objective lens 12, etc.

Subsequently, the controller 24 drives the focusing actuator of the objective lens 12 by the driver 20, thereby executing a focus search and turning on a focus servo.

Next, in accordance with a tracking error signal (differential push-pull signal) that is output from the RF amplifier 14, the controller 24 drives the tracking actuator of the objective lens 12 by the driver 22 and executes tracking control.

Thus, the focus servo and track servo are turned on, and various signals are generated on the basis of the signal which is output from the optical pickup head 11 in accordance with reflective light from the optical disc 10.

On the basis of the main push-pull signal Mpp that is output from the photodetector 41 of the optical pickup head 11 via the subtracter 43, the lens shift correction unit 24a of the controller 24 detects symmetry of this main push-pull signal Mpp. Based on the detected symmetry of the main push-pull signal, the lens shift correction unit 24a determines whether the balance of signal characteristics of the main push-pull Mpp signal is in the good state (balanced state) or not.

For example, in the case where the zero-cross point of the symmetry of the main push-pull signal Mpp agrees with the neutral point of the objective lens 12 (or in the case where the lens shift is within a preset range), it is determined that the balance is in the good state (balanced state).

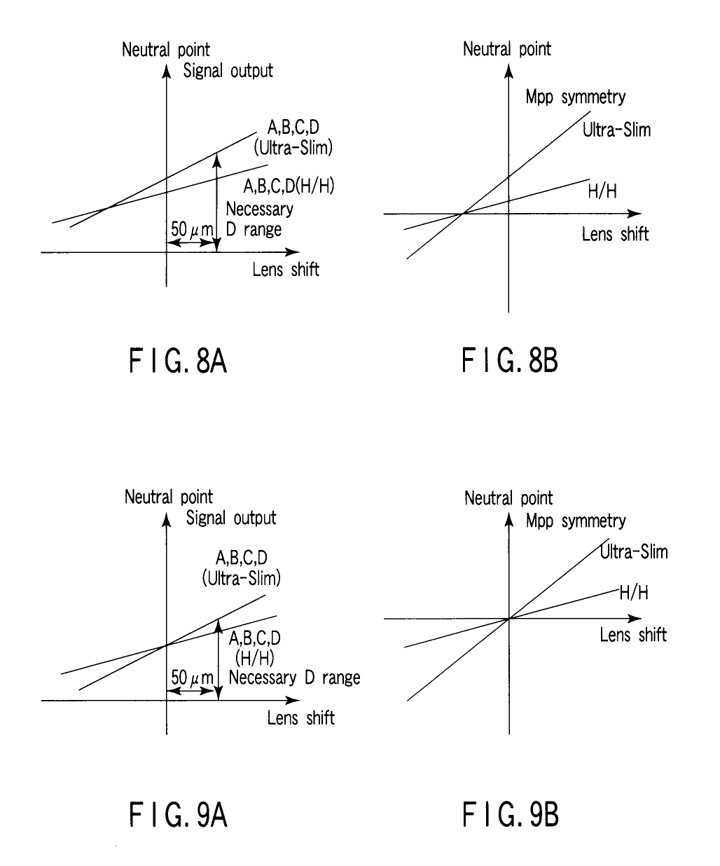

FIG. 8A shows the signal characteristics of the main push-pull signals in the ultra-slim type optical disc apparatus and in the thick (H/H) type optical disc apparatus, and FIG. 8B shows the symmetries of the main push-pull signals in the same apparatuses. The examples shown in FIG. 8A and FIG. 8B indicate that lens shifts occur due to the presence of warpage of the optical disc 10 or eccentricity inherent to the disc motor 32.

Consideration needs to be given to the fact that in the case where the optical disc apparatus is set to be an ultra-slim type, as shown in FIG. 8A, a greater variation occurs in the signal relative to the same lens shift amount, compared to the signal characteristics in the thick (H/H) type optical disc apparatus. For example, if the lens shift amount at this time is, e.g. 50 μm, as shown in FIG. 8A, a wider dynamic range is needed in the RF amplifier 14 of the ultra-slim type optical disc apparatus, than in the thick (H/H) type optical disc apparatus.

In the optical disc apparatus of the present embodiment, the lens shift, which occurs due to the influence of warpage of the optical disc 10 or eccentricity inherent to the disc motor 32, is corrected, and the zero-cross point of the symmetry is forcibly made to agree with the neutral point of the objective lens 12. Thereby, the occurrence of saturation is prevented without increasing the dynamic range of the RF amplifier 14.

On the basis of the main push-pull signal, the lens shift correction unit 24a detects the lens shift amount of the objective lens 12 so as to attain good balance of signal characteristics. For example, the lens shift correction unit 24a detects the lens shift amount for correcting the position of the objective lens 12 by shifting the objective lens 12 so that the output signal of the cells (A+D) of the photodetector 41 shown in FIG. 4 may become equal to the output signal of the cells (B+C).

The lens shift correction unit 24a stores the lens shift amount of the objective lens 12, for example, in a flash memory as the lens shift amount data 24b.

As shown in FIG. 3, the lens shift correction unit 24a constantly applies to the driver 22 the bias voltage (DC offset) corresponding to the lens shift amount data 24b. The driver 22 outputs the tracking driving signal to which the bias voltage is constantly applied, and drives the tracking actuator of the objective lens 12, thereby correcting the position of the objective lens 12.

FIG. 9A shows the signal characteristics of the main push-pull signals after the lens shifts are corrected in the ultra-slim type optical disc apparatus and the thick (H/H) type optical disc apparatus. FIG. 9B shows the symmetries of the main push-pull signals after the lens shifts are corrected in these apparatuses.

As shown in FIG. 9A, the position of the objective lens 12 is forcibly corrected to the position with no lens shift. Thereby, for example, the dynamic range, which is needed for the signal output at the position of the lens shift amount of 50 μm as in the case of FIG. 8A, becomes smaller than the dynamic range that was needed prior to the correction of the lens position.

In this manner, in the case where the balance of the signal characteristics of the main push-pull signal Mpp is not good (unbalanced), the position of the objective lens 12 is forcibly corrected and shifted to the position with no lens shift so as to attain good balance of signal characteristics. Thereby, there is no need to make the dynamic range of the RF amplifier 14 wider than necessary for the main push-pull signal Mpp. Therefore, the dynamic range of the RF amplifier 14 can effectively be utilized, and degradation in signal quality (S/N) can be prevented. In particular, in the case where the variation of the signal output relative to a unit lens shift amount is large as in the ultra-slim type optical disc apparatus, the dynamic range can be increased in accordance with the greatly varying output signal of the RF amplifier 14, and the occurrence of saturation can be prevented. Besides, there is no need to attenuate the output signal from the optical pickup head 11 in accordance with the dynamic range of the RF amplifier 14.

Next, another method of detecting the lens shift amount is described.

In this example, the lens shift amount is detected on the basis of the quality of a wobble signal which is generated on the basis of the main push-pull signal Mpp.

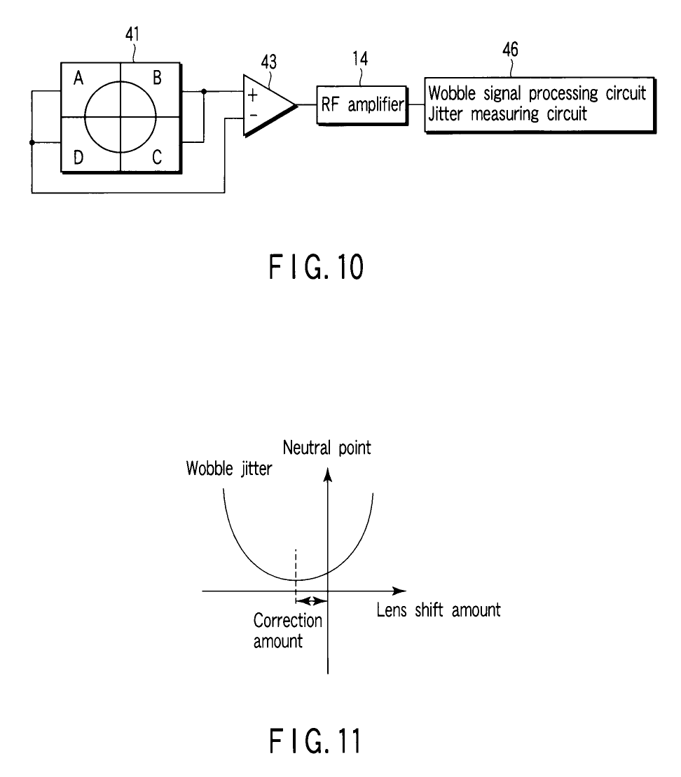

As shown in FIG. 10 (FIG. 2), using the main push-pull signal Mpp that is output from the subtracter 43, a wobble signal component is detected from the main push-pull signal Mpp by a wobble signal processing circuit 46, and the detected wobble signal component is input to a jitter measuring circuit so that jitter may be measured.

In this state, as shown in FIG. 11, the lens shift correction unit 24a finds such a lens shift point as to minimize the jitter, while shifting the objective lens 12, and stores the found lens shift amount. From the lens shift position that is found on the basis of the measurement result of jitter, the lens shift correction unit 24a detects the zero-cross point of the symmetry of the main push-pull signal MPP, and stores the difference of the lens shift amount as the lens shift amount data 24b.

Subsequently, when the operation for the optical disc 10 is actually executed, a bias voltage corresponding to the lens shift amount data 24b, which is detected on the basis of the jitter, is constantly applied to the driver 22, and the tracking actuator is driven.

In the above description, the jitter has been exemplified in the determination of the wobble signal quality. However, in the case where address information is superimposed on the wobble signal, the reading rate of address information may be checked and the optimal point at which the best reading rate is obtained may be regarded as the optical central point. An address detection circuit detects address information that is superimposed on the wobble signal, on the basis of the wobble signal that is generated by the wobble signal processing circuit 46. The address detection circuit detects the reading rate of the address information and outputs the detected value to the controller 24. The lens shift correction unit 24a of the controller 24 finds the lens shift position at which the best reading rate of address information is obtained, while shifting the objective lens 12, and sets the found lens shift position as the lens shift amount data 24b. The reading rate of address information may be detected by the controller 24.

Besides, the determination of the quality of the wobble signal may be executed on the basis of a carrier to noise ratio (C/N). In this case, the wobble signal component is detected by the wobble signal processing circuit 46, and the detected signal component is input to the a C/N measuring circuit, and the measurement of the C/N is executed. Subsequently, in the same manner as described above, the lens shift position at which the optimal C/N is obtained is found and set to be the optical central point.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical disc apparatus which executes tracking control for an objective lens by generating a push-pull signal, comprising:
a determination unit which detects symmetry of the push-pull signal and determines whether balance of signal characteristics of the push-pull signal is good;
a lens shift amount detection unit which detects, in a case where the determination unit determines that the balance of the signal characteristics of the push-pull signal is not good, a lens shift amount of the objective lens in such a manner as to improve the balance of the signal characteristics;
a memory unit which stores the lens shift amount that is detected by the lens shift amount detection unit; and
an addition unit which constantly applies the lens shift amount, which is stored in the memory unit, to a tracking actuator which shifts the objective lens.

2. The optical disc apparatus according to claim 1, wherein a main push-pull signal and a sub-push-pull signal are generated by a 3-beam method as said push-pull signal, and
the lens shift amount detection unit detects the lens shift amount on the basis of a quality of a wobble signal which is included in the main push-pull signal.

3. The optical disc apparatus according to claim 2, wherein the lens shift amount detection unit detects the lens shift amount, with which jitter of the wobble signal becomes optimal.

4. The optical disc apparatus according to claim 2, wherein the lens shift amount detection unit detects the lens shift amount, with which a reading rate of address information included in the wobble signal becomes optimal.

5. The optical disc apparatus according to claim 2, wherein the lens shift amount detection unit detects the lens shift amount, with which a C/N (carrier to noise ratio) relating to the wobble signal becomes optimal.

6. A lens shift correction method for correcting a position of an objective lens for which tracking control is executed on the basis of a push-pull signal, comprising:
detecting symmetry of the push-pull signal;
determining whether balance of signal characteristics of the push-pull signal is good, on the basis of the detected symmetry of the push-pull signal;
detecting, in a case where it is determined that the balance of the signal characteristics of the push-pull signal is not good, a lens shift amount of the objective lens in such a manner as to improve the balance of the signal characteristics; and
constantly adding the lens shift amount to a tracking actuator which shifts the objective lens.
